(19) United States
(12) Patent Application Publication
(10) Pub. No.: US 2018/0094770 A1
(43) Pub. Date: Apr. 5, 2018

(54) Lifting Apparatus

(71) Applicant: American System Integrators Inc, Irvine, CA (US)

(72) Inventors: Oliver Noval, Rancho Santa Margarita, CA (US); Grace NovaI, Rancho Santa Margarita, CA (US); Regina Blanca NovaI, San Marcos, CA (US); Ronia Bernardine NovaI, Rancho Santa Margarita, CA (US)

(21) Appl. No.: 15/283,469

(22) Filed: Oct. 3, 2016

(51) Int. Cl. F16M 13/02

(52) U.S. Cl. CPC F16M 13/022; F16M 2200/061; F16M 2200/00

(57) ABSTRACT

A lifting apparatus is configured to transport a load between a plurality of positions along a vertical structure. The present invention utilizes a first frame assembly comprising a plurality of first frame members, a first drive assembly, and a first side stabilizer; a second frame assembly comprising a plurality of second frame members, a second drive assembly, and a second side stabilizer; and a support assembly configured for supporting the load. In one aspect of the present invention the support assembly, the first frame assembly, and the second frame assembly, are configured to cooperate with one another to apply a gripping force to a surface of a vertical structure when a load is applied to the support assembly.

### COPYRIGHT

A portion of the disclosure of this patent document contains material, that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

### 1. Technical Field

The present invention relates generally to the field of lifting apparatus. More specifically, the present invention relates in one exemplary embodiment to a lifting, apparatus utilizing a support assembly to operably couple to various loads such e.g. lighting fixtures, security cameras, solar panels, antennas, wireless access points, platforms, booms, or other loads of any size) for movement between various positions along a longitudinal axis of a vertical structure.

### Description of Related Technology

Lifting or otherwise transporting a load from one position to another along a longitudinal axis of vertical structure is useful in various industries including security, telecommunications, utilities, sports, electronics, medical, industrial, and military. Numerous assemblies exist in the prior art for clamping, lifting, and supporting various loads relative to vertical structures.

For example, U.S. Pat. No. 8,037,630 to Crookham et al., filed Sep. 14, 2006, entitled “Bracket For Hanging Banner On Vertical Pole,” discloses an apparatus for holding a device along, the side of a vertical pole, which includes, a hanger bracket having one or more cross-arms adapted to be removably attached to the pole, and a locking, device that can be used for securing the brackets to the pole. U.S. Pat. No. 8,763,755 to Hagberg et al., filed Sep. 20, 2012, entitled “Portable Work Platforms and Method Therefor,” discloses a work platform capable of being mounted to a vertical post, having a strap assembly that is connected to the base and configured for use with a ratchet mechanism for tensioning the device to a vertical pole. U.S. Pat. No. 9,340,400 to Chong et al., filed Feb. 28, 2014, entitled “Load Lifting Assembly,” discloses a lifting assembly comprising a lifting unit, a load transporting unit, and a driving unit, wherein the lifting unit comprises a plurality of first and second bars or screws oriented in planes that cross each other, and bearing pairs mounted to the opposite ends of the bars or screws that contact the pole. U.S. Pat. No. 9,341,308 to Lacy, filed Jan. 13, 2015, entitled “Pole Clamp,” discloses a pole clamp for mounting a medical device to a pole and capable of being adapted to multiple pole cross-sections.

United States Patent Publication No. 2010/0207311 to Smith et al., published Aug. 19, 2010, entitled “Lifting Device Clamp Having A Curvilinear Surface,” discloses a clamp device comprising a plurality of arms, such that one of the arms includes a curvilinear surface the allows the clamp to engage an article having a curved surface. WIPO Publication No. 2011/042697 to Westlake, published. Apr. 14, 2011, entitled “A Bracket,” discloses a bracket capable of being coupled to a vertical post comprising a releasable mounting means for mounting the bracket to the pole. United States Patent Publication No. 2016/0178115 to Kho et al., published Jun. 23, 2016, entitled “Filter Bracket Mount For Existing Antenna Pole Mount,” discloses a mounting system comprising one or more mounting brackets and fasteners for mounting to a vertical post.

However, each of the aforementioned assemblies suffer from one or more disadvantages, including e.g. fixed mounting, manual operation, limited load capacity, and/or inability to support different type of devices. The above prior art references to Crookham, Hagberg, Chong, Lacy, Smith, Westlake, and Kho and all other extraneous materials discussed herein are incorporated herein by reference in their entirety. Where a definition or use of a term in an incorporation reference is inconsistent or contrary to the definition of that term provided herein, the definition of that term provided herein applies and the definition of that term in the reference does not apply.

Based on the foregoing, there is still a need for improved lifting apparatus capable of operably coupling to various loads and movable between multiple positions along a vertical structure.

### SUMMARY OF THE INVENTION

In a first aspect of the invention, a lifting apparatus is configured to transport a load between a plurality of positions along a vertical structure. In one embodiment, the lifting apparatus comprising: a first frame assembly comprising a plurality of first frame members, a first drive assembly and a first side stabilizer; a second frame assembly comprising a plurality of second frame members, a second drive assembly, and a second side stabilizer; a support assembly configured for supporting the load; a first set of actuator arms configured to operably couple the first frame assembly to the second frame assembly; and a second set of actuator arms configured to operably couple the support assembly to the second frame assembly. In one variant, the support assembly, the first frame assembly, and the second frame assembly, are configured to cooperate with one another to apply a first gripping force to a surface of the vertical structure when a first load is applied to the support assembly. In another variant, the support assembly, the first frame assembly, and the second frame assembly are configured to cooperate with one another to apply a second gripping force, greater than the first gripping force, to the surface of the vertical structure, when a second load is applied to the support assembly, wherein the second load is greater than the first load.

In a second aspect of the invention, a lifting apparatus is configured to transport a load between a plurality of positions along a vertical structure, in one embodiment, the apparatus comprises: a first frame assembly comprising a plurality of first frame members, a first drive assembly, and a first side stabilizer; a second frame assembly comprising a plurality of second frame members, a second drive assembly, and a second side stabilizer; a support assembly configured for supporting the load; a first set of actuator arms configured to operably couple the first frame assembly to the second frame assembly; and a second set of actuator arms configured to operably couple the support assembly to the second frame assembly.

In a third aspect of the invention, a lifting apparatus configured to transport a load between a plurality of positions along a vertical structure. In one embodiment, the apparatus comprises: a first frame assembly comprising a plurality of first frame members, a first drive assembly, and a first side stabilizer; a second frame assembly comprising a plurality of second frame members, a second drive assembly, and a second side stabilizer; a support assembly configured for supporting the load; a first set of actuator arms configured to operably couple the first frame assembly to the second frame assembly; and a second set of actuator arms configured to operably couple the support assembly to the second frame assembly; wherein the support assembly, the first frame assembly, and the second frame assembly, are configured to cooperate with one another in a scissor-like fashion, to apply a first gripping force to a surface of the vertical structure when a first load is applied to the support assembly; and wherein the support assembly, the first frame assembly, and the second frame assembly are configured to cooperate with one another in a scissor-like fashion, to apply a second gripping force, greater than the first gripping force, to the surface of the vertical structure, when a second load is applied to the support assembly, wherein the second load is greater than the first load.

Other features and advantages of the present invention will immediately be recognized by persons of ordinary skill in the art with reference to the attached drawings and detailed description of exemplary embodiments as given below.

### BRIEF DESCRIPTION OF THE DRAWINGS

The accompanying drawings illustrate various aspects and exemplary embodiments of the present invention disclosed herein, but should not be construed as restricting the scope of the invention in any manner. In the drawings, like reference numerals refer to the same or similar elements.

FIG. 1A is a perspective view illustrating one embodiment of a lifting apparatus according to the present invention.

FIG. 1B is a perspective view illustrating one embodiment of an upper frame assembly useful with the lifting apparatus shown in FIG. 1A according to the present invention.

FIG. 1C is a perspective view illustrating one embodiment of a lower frame assembly of the lifting apparatus shown in FIG. 1A according to the present invention.

FIG. 1D is a perspective view illustrating one embodiment of a support assembly useful with the lifting apparatus shown in FIG. 1A according to the present invention.

FIG. 2A is a perspective view illustrating one embodiment of a lower side stabilizer useful with the lifting apparatus according to the present invention.

FIG. 2B is another perspective view illustrating the embodiment of the lower side stabilizer shown in FIG. 2A useful with the lifting apparatus according to the present invention.

FIG. 3 is a perspective view illustrating one embodiment of an upper side stabilizer useful with the lifting apparatus according to the present invention.

FIG. 4 is a block diagram illustrating a side perspective view of one embodiment of the lifting apparatus according to the present invention.

FIG. 5 is a side perspective view illustrating a collapsed state of one embodiment of the lifting apparatus according to the present invention.

FIG. 6 is a block diagram of one embodiment of an electronic control system useful with the lifting apparatus according to the present invention.

All Figures© Copyright 2016. American System integrators. All rights reserved.

### DETAILED DESCRIPTION OF THE INVENTION

Exemplary embodiments of the apparatus of the present invention are now described in detail. Reference is made to the drawings, wherein like numerals refer to the same or similar parts throughout. It is noted that while the described apparatus of the present invention is described primarily with respect to a lifting apparatus configured for use in a vertical lifting environment, certain aspects of the present invention may be readily adapted to other types of lifting environments, including but not limited to horizontal or sloped. Hence, a myriad of other applications of the present invention are contemplated.

### Exemplary Apparatus

As illustrated and described herein, one feature of the present invention is the ability of lifting apparatus 100 to transport a load (not show), such as e.g. lighting fixtures, security cameras, solar panels, antennas, wireless access points, platforms, booms, and any other loads of any size, between multiple positions along a longitudinal axis (not shown) of a pole or other vertical structure (not shown) via operation of one or more drive assemblies.

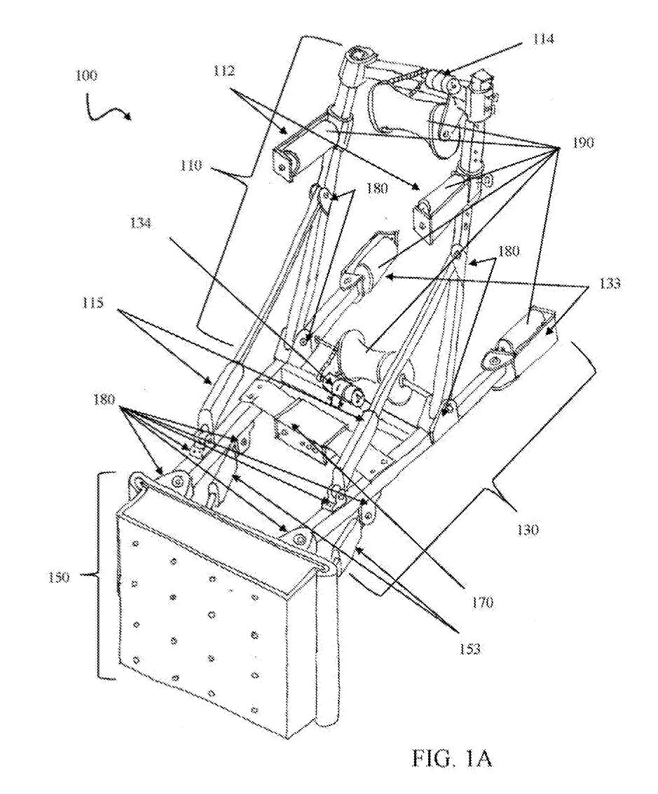

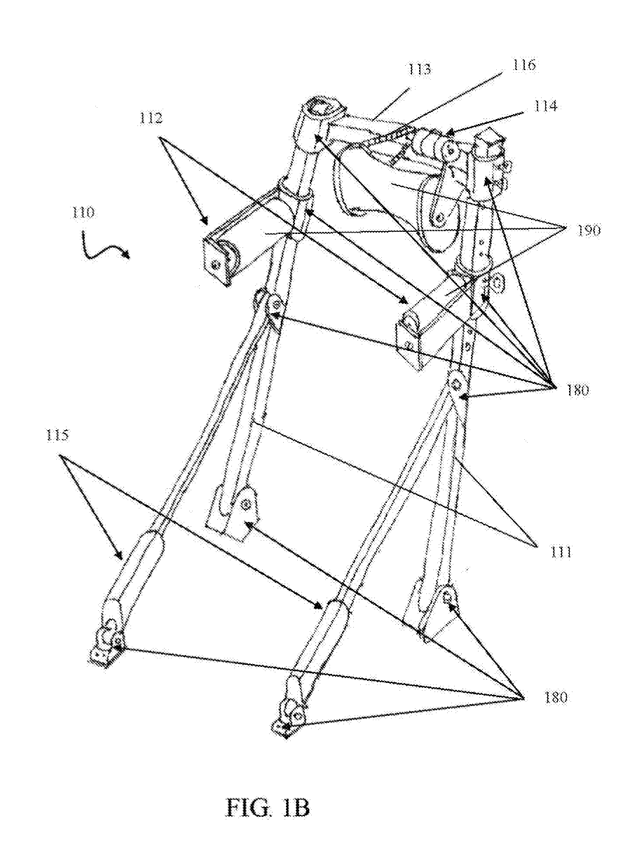

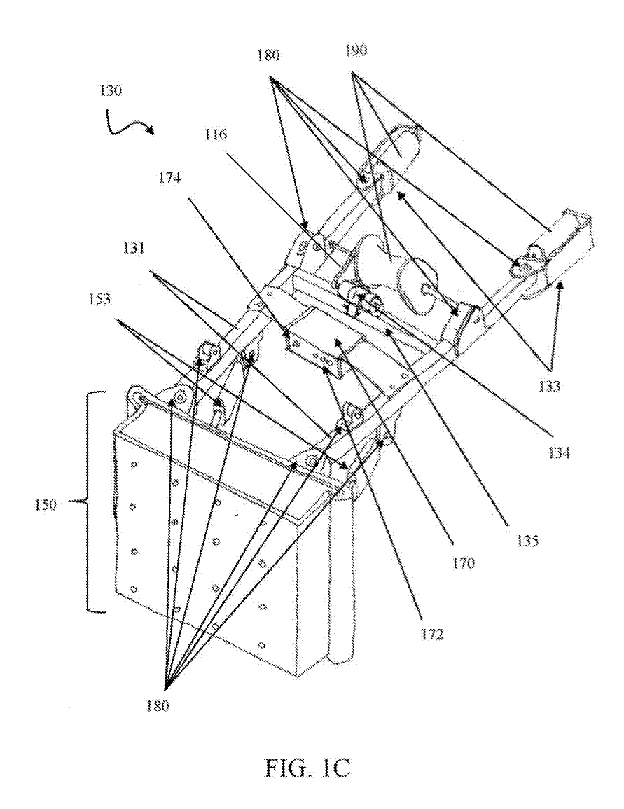

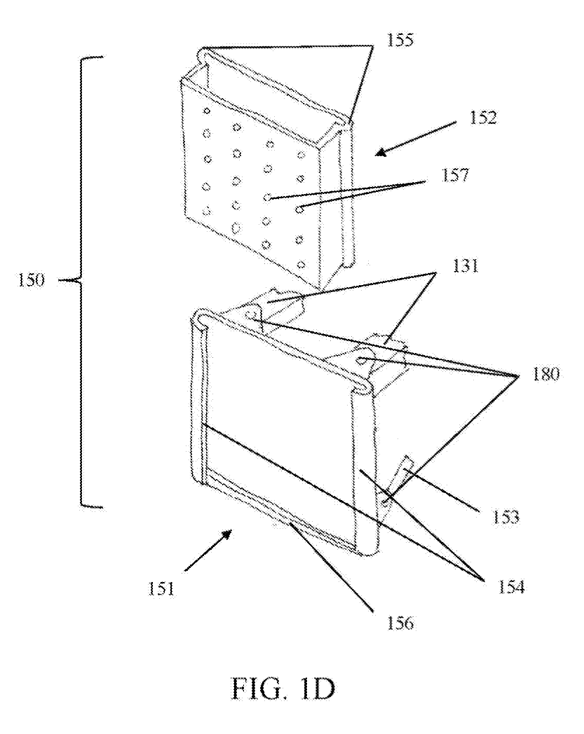

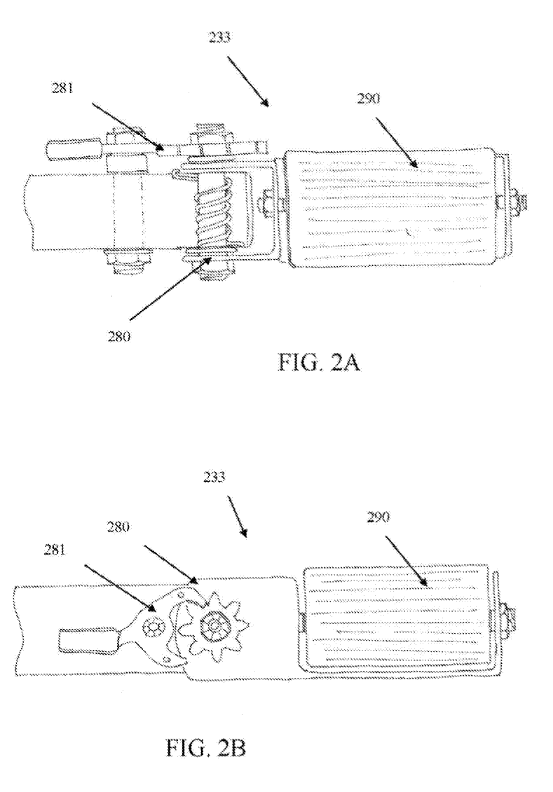

FIGS. 1A-1D depict one exemplary embodiment of the lifting apparatus 100 according to the present invention. Apparatus 100 generally comprises: upper frame assembly 110 with upper side stabilizers 112, upper arm actuators 115, and upper motor assembly 114; lower frame assembly 130 having lower side stabilizers 133, and lower motor assembly 134; support assembly 150 (described in greater detail in FIG. 1D infra) and support assembly actuators 153; and housing 170 configured to house one or more batteries and electronics (not shown).

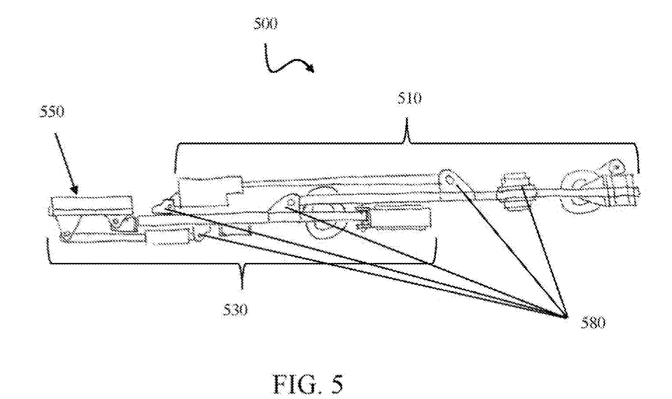

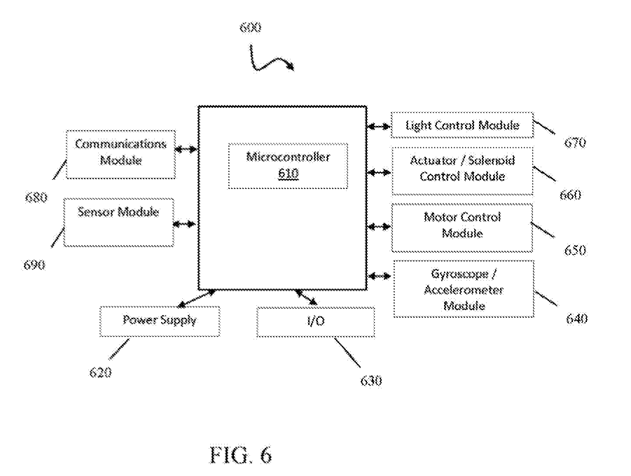

In exemplary embodiments, upper frame assembly 110, lower frame assembly 130, upper side stabilizers 112, lower side stabilizers 133, upper arm actuators 115, support assembly 150, and support assembly actuators 153 are configured to operably couple or mate to one another via a plurality of any suitable connectors, couplings, or fittings 180 necessary for the desired application, including but not limited to clamping, slidable, ball and socket, spring loaded, sealed gearing, solenoid controlled, rotatable, swiveling, and any other suitable connector, coupling, or fitting. It is contemplated that upper frame assembly 110 and lower frame assembly 130 are moveably coupled to one another such that the upper and lower frame assemblies are moveable in a scissor-like fashion. Additionally, in one variant, as shown in FIG. 5, lifting apparatus 500 is configured such that upper frame assembly 510, lower frame assembly 530, and load support assembly 550, couple to one another via a plurality of connectors, couplings, or fittings 580 in a collapsible manner, which allows assembly 530 to collapse into a portable suitcase like shape.

In exemplary embodiments, upper frame assembly 110, lower frame assembly 130 and other structural components can be constructed of any suitable materials to meet the desired lifting application, such as e.g. steel, aluminum, carbon fiber, epoxy bonded fiber, composites, and polymers such as e.g. High-density Polyethylene (HDPE), Polyvinyl Chloride (PVC), Polypropylene (PP), Acrylonitrile butadiene styrene (ABS), Polystyrene (PS) and Polylactic acid (PLA). It is further contemplated that said materials can have any suitable size and dimension, such as e.g. round, square, rectangular, angled, channel, flat, and T-shaped. Further, it is contemplated that the overall size and dimension of apparatus 100 can vary depending on whether it is for a small, medium, or large lifting application, and thither apparatus 100 can be configured to include a counter weight mechanism (not shown) to stabilize the apparatus 100 during operation.

In exemplary embodiments, it is contemplated that upper motor assembly 114 and lower motor assembly 134 can comprise any suitable motor for the desired lifting application, such as e.g. Direct Current (“DC”) motors (including but not limited to permanent magnet motors, separately excited motors, self-excited motors, series wound motors, shunt wound motors, compound wound motors, servo motors, and brushless DC motors), Alternating Current (“AC”) motors (including but not limited to synchronous motors, induction motors, and linear motors), stepper motors, hysteresis motors, and reluctance motors. In one variant, upper motor assembly 114 and lower motor assembly 134 comprise high torque DC motors. Still further, upper motor assembly 114 and lower motor assembly 134 can comprise the same or different motors.

It is contemplated that upper motor assembly 114 and lower motor assembly 134 can be configured to have an suitable drive mechanism to propel rollers 190, such as e.g. drive chains, drive belts, drive gears, flexible drive shafts, and direct drives. In one variant, as shown in FIGS. 1A-1C, upper motor assembly 114 and lower motor assembly 134 are configured to have a chain drive 116. It is contemplated that upper motor assembly 114 and lower motor assembly 134 can also be configured to allow operation in both a vertical axis relative to the vertical structure and rotatable about a horizontal axis of said vertical structure.

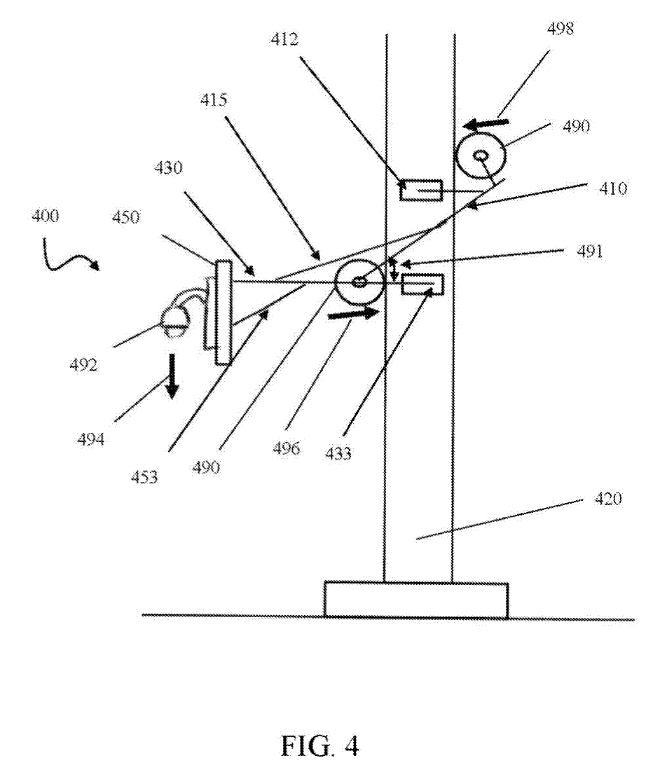

As shown in FIG. 1A, upper arm actuators 115 are configured to operably couple upper frame assembly 110 and lower frame assembly 130 and thereby allow the relative position of the upper frame assembly 110 to be controlled and/or adjusted with respect to the lower frame assembly 130. In exemplary embodiments, upper arm actuators 115 are configured to aid in increasing or decreasing the clamping or gripping force (as described in greater detail in FIG. 4, infra) applied to the surface of a vertical structure via the collaborative operation of upper frame assembly 110 and lower frame assembly 130 via rollers 190. It is also contemplated that support assembly actuators 153 are configured to operably couple support assembly 150 to lower frame assembly 130, thereby allowing the relative position of support assembly 150 to be controlled and/or adjusted with respect to lower frame assembly 130, such as to allow for the adjustment of support assembly 150 to accommodate different types of loads and to positioning of support assembly 150 during operation. In exemplary embodiments, upper arm actuators 115 and support assembly actuators 153 can comprise any suitable linear or non-linear actuators for the desired application, such as e.g. hydraulic actuators, pneumatic actuators, electrical actuators, thermal or magnetic actuators, and mechanical actuators.

In exemplary embodiments, rollers 190 can be constructed of any suitable materials to meet the desired lifting, gripping, friction, and strength requirements, such as e.g. rubber, foam, fabric, vinyl, nylon, polyester, kevlar, rayon, and other polymers and/or composites thereof. Still further, rollers 190 can be constructed to have any suitable size and dimension, such as e.g. round, hexagonal, convex, concave, threaded, and/or ridged. As used herein, the term “rollers” is used herein to mean any type of object capable of revolving around an axis thereby enabling the movement of apparatus 100 relative to the vertical structure, such as e.g. rollers, wheels, bearings, or similar object capable of revolving around an axis. It is contemplated that each of the rollers 190 used in conjunction with the upper motor assembly 114, lower motor assembly 134, upper side stabilizers 112, and lower side stabilizers 133 can all be the same or different depending on the desired lifting application. For example, in some applications rollers 190 of the upper motor assembly 114 and lower motor assembly 134 can be constructed of a first type of material having a first size and dimension; whereas rollers 190 of upper side stabilizers 112 and lower side stabilizers 133 can be constructed of a second type of material having a second size and dimension. It is further contemplated that the number of rollers 190 used in conjunction with each of the upper motor assembly 114, lower motor assembly 134, upper side stabilizers 112, and lower side stabilizers 133 can all be the same or vary based on the desired lifting application. For example, in some applications rollers 190 of the upper motor assembly 114 and lower motor assembly 134 can be constructed to have multiple independent segments, whereas rollers 190 of upper side stabilizers 112 and lower side stabilizers 133 can be constructed to have a single segment.

FIG. 1B depicts a perspective view of one embodiment of the upper frame assembly 110 useful with the lifting apparatus 100 according to the present invention. In exemplary embodiments, upper frame assembly 110 comprises: upper arm sections 111; upper side stabilizers 112 with rollers 190; cross member 113 with motor assembly 114 having roller 190; upper arm actuators 115 configured to operably couple upper arm sections 111 and lower frame assembly 130; and a plurality of connectors, couplings, or fittings 180 for coupled the various components of upper frame assembly thereby enabling movement of the various components relative to one another.

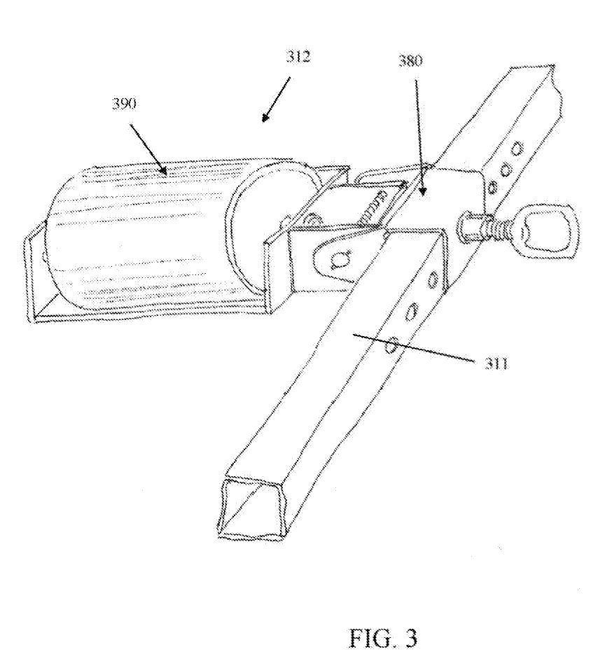

It is contemplated that upper side stabilizers 112 are configured to stabilize lateral movement of apparatus 100 during operation. Upper side stabilizers 112 can additional include tensioning assemblies (not shown) configured to apply a force to create or maintain tension, such as e.g. coil springs, hydraulic, pneumatic, or gravity acting against a suspended mass. The tensioning assemblies are configured to stabilize lateral movement of the apparatus 100 during operation and to thereby assist in increasing the applied clamping or gripping force the surface of vertical structure (not shown) via rollers 190. In one variant, as shown in FIG. 3, upper side support member 312 is configured to include roller 390 and a pivotal connector, coupling, or fitting 380 that allows upper side support member 312 to be foldable with respect to the upper arm section, and wherein said connector, coupling, or fitting 380 is further configured to be moveable or slidable along upper arm section 311. In one variant, cross member 113 can be configured to include an emergency stop mechanism (not shown) to halt and/or disable the movement of apparatus 100 during operation if an obstruction is detected or hit, or a rescue removal attachment configured to allow apparatus 100 to rescue and/or retrieve other non-functioning apparatus stuck on the vertical structure.

FIG. 1C depicts a perspective view of one embodiment of the lower frame assembly 130 useful with the lifting apparatus 100 according to the present invention. In exemplary embodiments, lower frame assembly 130 comprises: lower arm sections 131; lower side stabilizers 133 with rollers 190; cross member 135 configured to operably couple lower motor assembly 134 having roller 190; support assembly actuators 153 configured to operably couple support assembly 150 and lower arm sections 131; a plurality of connectors, couplings, or fittings 180; and a control housing 170 for housing one or more batteries and electronics (not shown). Control housing 170 can be configured to include LED lights 172, and a door with locking mechanism 174 for controlling access to the electronics housed therein. It is contemplated that lower side stabilizers 133 are configured to stabilize lateral movement of apparatus 100 during operation. Lower side stabilizers 133 can additional include tensioning assemblies (not shown) configured to apply a force to create or maintain tension, such as e.g. coil springs, hydraulic, pneumatic, or gravity acting against a suspended mass. The tensioning assemblies are configured to stabilize lateral movement of the apparatus 100 during operation and to thereby assist in increasing the applied clamping or gripping force the surface of vertical structure (not shown) via rollers 190. In one variant, as shown in FIGS, 2A-2B lower side support member 233 is configured to include roller 290 and spring tensioned pivotal connector, coupling, or fitting 280, which includes an adjustable locking/gear mechanism 281 to allow lower side support member 233 to be foldable.

FIG. 1D depicts one embodiment of a support assembly 150 useful with the lifting apparatus 100 according to the present invention. In exemplary embodiments, support assembly 150 comprises a support assembly receiver 151 configured to receive removable face plate 152. Support assembly receiver 151 is configured to operably couple to lower arm sections 131 and support assembly actuators 153 of the lower frame assembly 130 via a plurality of connectors, couplings, or fittings 180. In one variant, as shown in FIG. 1D, support assembly receiver 151 can comprise stop portion 156 and a pair of vertical receiving slots 154 for receiving rails 155 extending from removable face plate 152, thereby allowing support assembly receiver 151 to receive removable face plate 152. In alternative embodiments, support assembly receiver 151 can comprise horizontal receiving portions for receiving removable face plate 152. Additionally, other suitable mating means are contemplated for coupling support assembly receiver 151 to removable face plate 152, such as e.g. pivotal locking tabs, magnetic means, screws, bolts, and any other suitable mating means. Removable face plate 152 can be configured to include a plurality of premade holes 157 for attaching a load to removable face plate 152. However, any suitable attachment means may be utilized for attaching a load to the face plate 152. Further, it is contemplated that support assembly 150 can be directly coupled to a load without use of the removable face plate, such as e.g. in platform and boom application couple of human transport.

As shown in FIG. 4, apparatus 400 is configured to transport load 492 (e.g. security camera) between multiple positions along a longitudinal axis of a vertical structure 420. Apparatus 400 comprises: upper frame assembly 410; upper side support member 412; upper arm actuator 415 operably coupled to upper frame assembly 410 and lower frame assembly 430; upper motor assembly (not shown) having roller 490; lower side support member 433; lower motor assembly (not shown) having roller 490; and support assembly 450 operably coupled to lower frame assembly 430 via support assembly actuator 453. It is further contemplated that rollers 490 of the upper motor assembly (not shown) and lower motor assembly (not shown can be coupled to their respective structural supports with tensioning assemblies (not shown) to aid in the clamping or gripping force that is applied to the surface of the vertical structure 420.

As illustrated in FIG. 4, when load 492 is applied to support assembly 450, a downward force is applied (as depicted by arrow 494) to support assembly 450, thereby increasing a clamping or gripping force (as depicted by arrows 496 and 498) to be applied to the surface of vertical structure 420 though rollers 490, via the collaborative operation of support assembly 450, upper frame assembly 410, lower frame assembly 430, upper arm actuator 415, and tension assemblies (not shown), in a scissor-like fashion. One object of the present invention, is that as the weight of the load applied to support assembly 450 increases, so too does the resultant force that is applied to the vertical structure. As shown in FIG. 4, operational angle 491 exists between upper frame assembly 410 and lower frame assembly 430, which can be adjusted for providing optimal lifting traction. Operational angle 491 is preferred to be between 20-70 degrees, more preferably between 35-55 degrees, and most preferably 45 degrees.

### Exemplary Electronic System

FIG. 6 depicts a functional block diagram of one exemplary embodiment of an electronic subsystem 600 for use with the present invention. One of ordinary skill in the art will appreciate that subsystem 600 may include, without limitation, many additional components not shown, such as e.g. one or more user devices such as e.g. mobile phones, smartphones, tablets, wearable devices, with or without GPS or location services), and other network components. As shown in FIG. 6, electronic subsystem 600 comprises: microcontroller 610; power supply 620 (which can comprise one or more batteries); input/output module 630 for connecting various input and/or output devices; Gyroscope/Accelerometer Module for maintaining the optimal positioning of the lifting apparatus during operation; motor control module 650 configured to control the vertical positioning of the lifting apparatus; actuator/solenoid control module 660 for assisting and/or controlling the applied force to the vertical structure; light control module 670; communications module 680 (e.g. GPS, and/or Bluetooth transceivers and network interface controllers (NICs); and a sensor module 690 configured to monitor various aspect of the device, such as e.g. emergency stop mechanism.

While the above detailed description has shown, described, and pointed out novel features of the invention as applied to various embodiments, it will be understood that various omissions, substitutions, and changes in the form and details of the systems, apparatus, and methods illustrated may be made by those skilled in the art without departing from the invention. The description is in no way meant to be limiting, but rather should be taken as illustrative of the general principles of the invention. The scope of the invention should be determined with reference to the claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A lifting apparatus configured to transport a load between a plurality of positions along a vertical structure, said apparatus comprising:
a first frame assembly comprising a plurality of first frame members, a first drive assembly, and a first side stabilizer;
a second frame assembly comprising a plurality of second frame members, a second drive assembly, and a second side stabilizer;
a support assembly configured for supporting said load;
a first set of actuator arms configured to operably couple said first frame assembly to said second frame assembly; and
a second set of actuator arms configured to operably couple said support assembly to said second frame assembly;
wherein said support assembly, said first frame assembly, and said second frame assembly, are configured to cooperate with one another to apply a first gripping force to a surface of said vertical structure when a first load is applied to said support assembly; and
wherein said support assembly, said first frame assembly, and said second frame assembly are configured to cooperate with one another to apply a second gripping force, greater than said first gripping force, to said surface of said vertical structure, when a second load is applied to said support assembly, wherein said second load is greater than said first load.

2. The lifting apparatus of claim 1, wherein said first frame assembly further comprises a third side stabilizer.

3. The lifting apparatus of claim 2, wherein said first frame assembly further comprises a first cross member configured to be coupled to said first drive assembly.

4. The lifting apparatus of claim 3, wherein said first drive assembly further comprises a first roller configured to contact a surface of said vertical structure.

5. The lifting apparatus of claim 4, wherein said first side stabilizer of said first frame assembly further comprises a second roller, and wherein said third side stabilizer of said first frame assembly further comprises a third roller, wherein said second and third rollers are configured to contact said surface of said vertical structure.

6. The lifting apparatus of claim 1, wherein said second frame assembly further comprises a fourth side stabilizer.

7. The lifting apparatus of claim 6, wherein said second frame assembly further comprises a second cross member configured to be coupled to said second drive assembly.

8. The lifting apparatus of claim 7, wherein said second drive assembly further comprises a fourth roller configured to contact a surface of said vertical structure.

9. The lifting apparatus of claim 8, wherein said second side stabilizer of said second frame assembly further comprises a fifth roller, and wherein said fourth side stabilizer of said second frame assembly further comprises a sixth roller, wherein said fifth and sixth rollers are configured to contact said surface of said vertical structure.

10. The lifting apparatus of claim 1, wherein said support assembly further comprises a support assembly receiver and a removable face plate.

11. The lifting apparatus of claim 1, wherein said support assembly, said first frame assembly, and said second frame assembly, are configured to cooperate with one another in a scissor-like fashion, to apply a first gripping force to a surface of said vertical structure when a first load is applied to said support assembly.

12. The lifting apparatus of claim 11, wherein said support assembly, said first frame assembly, and said second frame assembly are configured to cooperate with one another in a scissor-like fashion, to apply a second gripping force, greater than said first gripping force, to said surface of said vertical structure, when a second, load is applied to said support assembly, wherein said second load is greater than said first load.

13. The lifting apparatus of claim 1, wherein said first frame assembly is spatially oriented with respect to said second frame assembly to comprise an operation angle of 45 degrees.

14. The lifting apparatus of claim 1, wherein said first side stabilizer and second side stabilizer are foldable.

15. The lifting apparatus of claim 1, further comprising an emergency stop mechanism configured to detect the presence of an obstruction and thereby disable said apparatus when said obstruction is detected.

16. A lifting apparatus configured to transport a load between a plurality of positions along a vertical structure, said apparatus comprising:
a first frame assembly comprising a plurality of first frame members, a first drive assembly, and a first side stabilizer;
a second frame assembly comprising a plurality of second frame members, a second drive assembly, and a second side stabilizer;
a support assembly configured for supporting said load;
a first set of actuator arms configured to operably couple said first frame assembly to said second frame assembly; and
a second set of actuator arms configured to operably couple said support assembly to said second frame assembly.

17. A lifting apparatus configured to transport a load between a plurality of positions along a vertical structure, said apparatus comprising:
a first frame assembly comprising a plurality of first frame members, a first drive assembly, and a first side stabilizer;
a second frame assembly comprising a plurality of second frame members, a second drive assembly, and a second side stabilizer;
a support assembly configured for supporting said load;
a first set of actuator arms configured to operably couple said first frame assembly to said second frame assembly; and
a second set of actuator arms configured to operably couple said support assembly to said second frame assembly;
wherein said support assembly, said first frame assembly, and said second frame assembly, are configured to cooperate with one another in a scissor-like fashion, to apply a first gripping force to a surface of said vertical structure when a first load is applied to said support assembly; and
wherein said support assembly, said first frame assembly, and said second frame assembly are configured to cooperate with one another in a scissor-like fashion, to apply a second gripping force, greater than said first gripping force, to said surface of said vertical structure, when a second load is applied to said support assembly, wherein said second load is greater than said first load.
